(19) United States
(12) Patent Application Publication
(10) Pub. No.: US 2022/0027636 A1
(43) Pub. Date: Jan. 27, 2022

(54) Target Task Intention Identifying Method and Device Based on Unit Distribution Thermal Grid

(71) Applicant: National University of Defense Technology, Changsha City (CN)

(72) Inventors: Yulong Zhang, Beijing (CN); Jincai Huang, Changsha City (CN); Li Chen, Yinchuan City (CN); Guangquan Cheng, Changsha (CN); Yanghe Feng, Changsha City (CN); Min Li, Beijing (CN); Keyu Wu, Changsha City (CN); Rui Wang, Beijing (CN); Qipeng Yin, Changsha City (CN); Yang Ding, Urumqi City (CN)

(21) Appl. No.: 17/379,182

(22) Filed: Jul. 19, 2021

(30) Foreign Application Priority Data
Jul. 20, 2020 (CN) 202010697759.5

(51) Int. Cl. G06K 9/00; G06K 9/62; G05D 1/10

(52) U.S. Cl. CPC G06K 9/00771; G05D 1/104; G06K 9/6267

(57) ABSTRACT

The present application relates to a target task intention identifying method and device based on a unit distribution thermal grid. The method comprises: converting the task space into latitude and longitude grids according to the latitudes and longitudes; according to locations of flying targets and task radiuses, constructing an aerial unit distribution thermal grid in the task space; according to the thermal value of the grid and the associated flying targets, determining a task suspected formation in the task space; judging whether or not each task suspected formation is a target formation according to the principle of time and space consistency; and determining task intention of the target formation according to the platform type of the flying targets in the obtained target formation and the task type of the task target in the task area. The method can be adopted to directly identify the formation of the flying targets, the task area and the task intention according to real-time obtained information such as the platform type of the flying targets, the flying trajectory, the location of the task target, the type of the task target, and the like, so that the problem that a conventional way needs support of prior knowledge and algorithm training is solved.

### CROSS REFERENCE TO RELATED APPLICATION

The disclosure relates to the technical field of target identification, and particularly to a target task intention identifying method and device based on a unit distributed thermal grid.

### BACKGROUND OF THE INVENTION

When a plurality of reconnaissance planes, fighter planes, Unmanned Aerial Vehicles (UAVs) and other flying platforms perform tasks, different flying formation methods are generally selected according to the type of tasks so as to ensure the coordinated command and control capabilities among the platforms to complete more complex tasks in a larger area. Common formation methods include horizontal formation, arrow formation, rhombic formation, etc., according to the formation forms. According to the spacing, distance, and height difference of the platforms, the common formation methods include basic formation, dense formation, and open formation, evacuation formation, etc.

At present, the method of identifying flying target formations and intentions thereof is mainly based on the concept and technical framework of situation awareness. Situation templates, expert systems, Bayesian networks, and deep learning methods are used to identify battlefield situations. The flying target formations and task intentions thereof are identified among the flying targets. However, these methods all require a large amount of prior knowledge as data support, and the establishment of a situation template library in the early stage, the expert system, the Bayesian network, deep learning algorithm training, etc. requires a lot of time and energy. Information can be obtained in real time without the platform type of a flying target, a flying trajectory, a task target location, a task target type and the like for directly identifying target formation, task area and task intention of the flying target.

### SUMMARY OF THE INVENTION

Based on this, it is necessary to provide a target task intention identifying method and device based on a unit distributed thermal grid for solving the technical problems, which can directly identify target formation, task area and task intention of the flying targets according to the platform type of the flying targets, a flying trajectory, a task target location, a task target type and the like.

A target task intention identifying method based on a unit distribution thermal grid, includes:

obtaining latitude and longitude data of a task space;

converting the task space into latitude and longitude grids according to the latitude and longitude data;

according to current locations of flying targets and preset task radiuses, associating the latitude and longitude grids as the thermal association grid of the flying targets;

according to the thermal association grid associated with the flying targets in the task space, constructing an aerial unit distribution thermal grid;

according to the thermal value of the aerial unit distribution thermal grid and the flying targets associated with the aerial unit distribution thermal grid, determining suspected task formation data in the task space;

obtaining a suspected task area and a flying target trajectory corresponding to the suspected task formation data, and determining target formation of the task suspected formation data and the task area of the target formation according to the principle of time and space consistency; and

according to the platform type of the flying targets in the target formation and the task target type of the task target in the task area, determining task intention of the target formation.

one embodiment, the step of constructing the aerial unit distribution thermal grid according to the thermal association grid associated with the flying targets in the task space includes:

according to the thermal association grid associated with the flying targets in the task space, obtaining the number of times that the latitude and longitude grids are associated with the thermal association grid of the flying targets; and

generating a thermal value of the latitude and longitude grid according to the number of times, and constructing an aerial unit distribution thermal grid.

one embodiment, the step of determining suspected task formation data in the task space according to the thermal value of the aerial unit distribution thermal grid and the flying targets associated with the aerial unit distribution thermal grid includes:

obtaining the aerial unit distribution thermal grid with the largest thermal value when the thermal value of the aerial unit distribution thermal grid in the task space is greater than the preset value, generating a task suspected formation based on the flying targets associated with the aerial unit distribution thermal grid and deleting the flying targets and thermal association grid corresponding to the task suspected formation; and

according to the task suspected formation, determining the task suspected formation data in the task space.

In one embodiment, the step of obtaining a suspected task area of task suspected formation data, and determining target formation of the task suspected formation data and a task area of the target formation according to the principle of time and space consistency includes:

assuming that the task suspected formation data in the task space include m task suspected formations f₁, f₂, . . . fₘ, where the task suspected formation fᵢ includes n flying targets pᵢ₋₁, pᵢ₋₂, . . . pᵢ₋ₙ; assuming that the longitude and latitude values at the moment T of the flying targets are lonₚ(T) and latₚ(T), respectively, assuming that the current moment is T₀, and the previous j moments from near to far are T₋₁, T₋₂, T₋₃, T₋₄, . . . T₋ₖ . . . T₋ⱼ, obtaining the latitude and longitude values of the n flying targets of the task suspected formation fᵢ at the moments T₀, T₋₁, T₋₂, T₋₃, . . . T₋ₖ . . . T₋ⱼ, where k is greater than 0 and smaller than j;

according to the latitude and longitude values, calculating latitude and longitude endpoint values of the task suspected formation fᵢ at T−k, T−(k+1), T−j as follows:

$$\{ \begin{matrix}{lat}_{max} ( T ) = max ( {lat}_{{p}_{i - 1}} ( T ) , {lat}_{{p}_{i - 2}} ( T ) , … , {lat}_{{p}_{i - n}} ( T ) ) \\ {lon}_{max} ( T ) = max ( {lon}_{{p}_{i - 1}} ( T ) , {lon}_{{p}_{i - 2}} ( T ) , … , {lon}_{{p}_{i - n}} ( T ) ) \\ {lat}_{min} ( T ) = min ( {lat}_{{p}_{i - 1}} ( T ) , {lat}_{{p}_{i - 2}} ( T ) , … , {lat}_{{p}_{i - n}} ( T ) ) \\ {lon}_{min} ( T ) = min ( {lon}_{{p}_{i - 1}} ( T ) , {lon}_{{p}_{i - 2}} ( T ) , … , {lon}_{{p}_{i - n}} ( T ) )\end{matrix}$$

according to the latitude and longitude endpoint values, calculating an average latitude and longitude endpoint value of the task suspected formation fᵢ at moments T−k, T−(k+1), . . . T−j as follows:

$$\{ \begin{matrix}{lat}_{argmax} = ( {lat}_{max} ( {T}_{- k} ) + {lat}_{max} ( {T}_{- ( k + 1 )} ) + … + {lat}_{max} ( {T}_{- j} ) ) / ( j - k + 1 ) \\ {lon}_{argmax} = ( {lon}_{max} ( {T}_{- k} ) + {lon}_{max} ( {T}_{- ( k + 1 )} ) + … + {lon}_{max} ( {T}_{- j} ) ) / ( j - k + 1 ) \\ {lat}_{argmax} = ( {lat}_{min} ( {T}_{- k} ) + {lat}_{min} ( {T}_{- ( k + 1 )} ) + … + {lat}_{min} ( {T}_{- j} ) ) / ( j - k + 1 ) \\ {lon}_{argmax} = ( {lon}_{min} ( {T}_{- k} ) + {lon}_{min} ( {T}_{- ( k + 1 )} ) + … + {lon}_{min} ( {T}_{- j} ) ) / ( j - k + 1 )\end{matrix}$$

obtaining the suspected task area of the task suspected formation based on the average longitude and latitude endpoint value;

according to the latitude and longitude values of the flying targets of the task suspected formation fᵢ at moments T₀, T₋₁, . . . T₋₍ₖ₋₁₎, obtaining frequency of appearances of the flying targets in the suspected task area and the position, on the center point of the suspected task area, of the target formation at moments T₀, T₋₁, . . . T₋₍ₖ₋₁₎;

obtaining the number of flying targets whose frequency of appearances is greater than a preset value, determining the task suspected formation f as the target formation and determining the corresponding suspected task area as a task area of the target formation when the frequency is greater than the preset value and a distance between location of the center point to the flying targets is smaller than the preset value.

In one embodiment, the step of converting the task space into a latitude and longitude grid according to the latitude and longitude data includes:

assuming that the latitude and longitude endpoint values of the task space are Latₛ, Latₑ, Lon_{g}, and Lonₑ, and dividing the task space into a latitude and longitude grid with a latitude value interval being L_{Dlat} and a longitude value interval being L_{Dlon} according to a preset length D;

Assuming that a latitude serial number of the latitude and longitude grid is Nₗₐₜ and a longitude serial number is Nₗₒₙ, generating a mapping relationship among the generated latitude serial number, the longitude serial number and the latitude and longitude grid as follows:

$$\{ \begin{matrix}[ {Lat}_{s} , {Lat}_{s} + {N}_{lat} \times {L}_{Dlat} ] , {N}_{lat} = 1 \\ ( {Lat}_{s} + ( {N}_{lat} - 1 ) \times {L}_{Dlat} , {Lat}_{s} + {N}_{lon} \times {L}_{Dlat} ] , 1 < {N}_{lat} < ⌈ {Lat}_{e} / {L}_{Dlon} ⌉ \\ ( {Lat}_{s} + ( {N}_{lat} - 1 ) \times {L}_{Dlat} , {Lat}_{e} ] , {N}_{lat} = ⌈ {Lat}_{e} / {L}_{Dlat} ⌉\end{matrix} \\ \{ \begin{matrix}[ {Lon}_{s} , {Lon}_{s} + {N}_{lon} \times {L}_{Dlon} ] , {N}_{lon} = 1 \\ ( {Lon}_{s} + ( {N}_{lon} - 1 ) \times {L}_{Dlon} , {Lon}_{s} + {N}_{lon} \times {L}_{Dlon} ] , 1 < {N}_{lat} < ⌈ {Lat}_{e} / {L}_{Dlat} ⌉ \\ ( {Lon}_{s} + ( {N}_{lon} - 1 ) \times {L}_{Dlon} , {Lon}_{e} ] , {N}_{lon} = ⌈ {Lon}_{e} / {L}_{Dlon} ⌉\end{matrix} .$$

In one embodiment, the step of associating the latitude and longitude grid as the thermal association grid of the flying targets according to the current locations of the flying targets and preset task radiuses includes:

according to the task radiuses of the flying targets, determining a task area of the flying targets; and

according to the current locations of the flying targets, associating the latitude and longitude grids covered by the task area with the thermal association grid of the flying targets.

In one embodiment, the step of determining task intention of the target formation according to the platform type of the flying targets in the target formation and the task target type of the task target in the task area includes:

when the platform type of the flying targets in the target formation is a to-air platform or an unknown platform, and the task target type of the task target in the task area includes an aerial target, determining that the task intention of the target formation is a close-range aerial confrontation;

when the platform type of the flying targets in the target formation is a to-air platform or an unknown platform, and the task target type of the task target in the task area is only a ground target, determining task intention of the target formation to be an air-to-ground confrontation;

when the platform type of the flying targets in the target formation is a ground platform, and the task target type of the task target in the task area includes an aerial target, determining the task intention of the target formation to be a close-range aerial confrontation;

when the platform type of the flying targets in the target formation is a ground platform, and the task target type of the task target in the task area is only a ground target, determining the task intention of the target formation to be an air-to-ground confrontation; and

when the task target is not detected in the task area, determining the task intention of the target formation to be assembled on standby.

A target task intention identifying device based on unit distribution thermal grid, includes:

a latitude and longitude data obtaining module for obtaining latitude and longitude data of a task space;

a latitude and longitude grid generating module for converting the task space into a latitude and longitude grid according to the latitude and longitude data;

a thermal association grid associating module for associating the latitude and longitude grid as the thermal association grid of the flying targets according to the current locations of the flying targets and preset task radiuses;

an aerial unit distribution thermal grid constructing module for constructing an aerial unit distribution thermal grid according to the thermal association grid associated with the flying targets in the task space;

a task suspected formation identifying module for determining suspected task formation data in the task space according to the thermal value of the aerial unit distribution thermal grid and the flying targets associated with the aerial unit distribution thermal grid;

a target formation identifying module for obtaining a suspected task area and a flying target trajectory corresponding to the suspected task formation data, and determining target formation of the task suspected formation data and the task area of the target formation according to the principle of time and space consistency; and

a task intention identifying module for determining task intention of the target formation according to the platform type of the flying targets in the target formation and the task target type of the task target in the task area.

Computer equipment includes a memory and a processor, where the memory stores a computer program, when executed by a processor, that implements the steps of the method in any one of the foregoing embodiments.

A computer-readable storage medium stores computer program, when executed by a processor, that implements the steps of the method in any one of the foregoing embodiments.

The target task intention identifying method and device based on the unit distributed thermal grid, the computer equipment and the storage medium establish the aerial unit distribution thermal grid of the task space and the thermal value thereof according to the task radiuses, the current location, the trajectory and the longitude and latitude data of the task space of the flying target, determine the task suspected formation in the task space according to the thermal value and the flying targets associated with the aerial unit distribution thermal grid, identify the target formation and the task area thereof from the task suspected formation according to the principle of time and space consistency, and determine the task intention of the target formation according to the platform type of the flying targets in the target formation and the task target type of the task target in the task area. The target task intention identifying method and device based on the unit distributed thermal grid, the computer equipment and the storage medium can directly identify the target formation, the task area and the task intention of the flying targets according to real-time obtained information such as the platform type of the flying target, the flying trajectory, the location of the task target, the type of the task target and the like, thereby avoiding the problems of needing a great deal of priori knowledge as a data support, and needing a great deal of time and energy for establishing a database and a training algorithm while situation templates, expert systems, Bayesian networks, and deep learning methods are used to identify battlefield situations.

### BRIEF DESCRIPTION OF THE FIGURES

FIG. 1 is an application scenario diagram of a target task intention identifying method based on a unit distributed thermal grid in one embodiment;

FIG. 2 is a flow chart of a target task intention identifying method based on a unit distributed thermal grid in one embodiment;

FIG. 3 is a schematic diagram showing a thermal value of a unit distribution thermal grid in an embodiment;

FIG. 4 is a schematic diagram showing a thermal value of a unit distribution thermal grid in another embodiment;

FIG. 5 is a schematic diagram showing a method for identifying task suspected formation data based on a unit distribution thermal grid in an embodiment;

FIG. 6 is a schematic diagram showing a method for identifying task suspected formation data based on a unit distribution thermal grid in another embodiment; and

FIG. 7 is a diagram showing an internal structure of computer equipment in an embodiment.

### DETAILED DESCRIPTION OF THE PREFERRED EMBODIMENTS

In order to make the purpose, technical scheme and advantages of the present application clearer and more understood, the present application will be further illustrated in detail in combination with accompanying figures and embodiments hereinafter. It should be understood that the specific embodiments described here are only used to explain the present application, and not used to limit the present application.

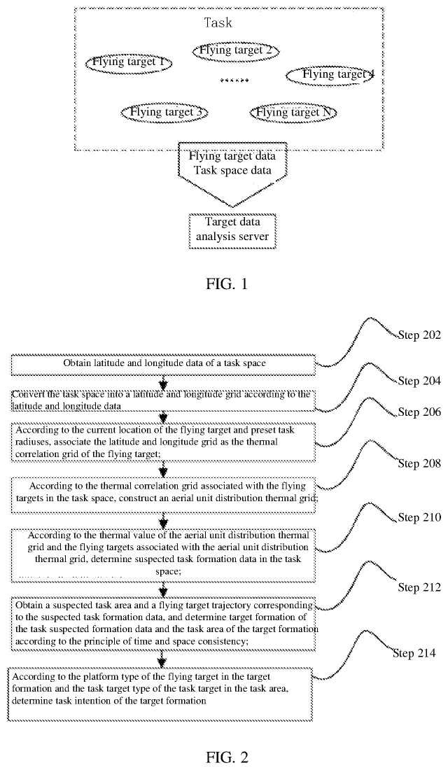

The target task intention identifying method based on the unit distributed thermal grid provided in the present application can be applied to a target data analysis server in a scenario as shown in FIG. 1. The target data analysis server receives the longitude and latitude data of the task space and the task radiuses, the current location and the trajectory data of N flying targets in the task space. The target data analysis server can be implemented by an independent server or a server cluster consisting of a plurality of servers.

In one embodiment, as shown in FIG. 2, a target task intention identifying method based on a unit distribution thermal grid is provided. Taking the method applied to the target data analysis server in the scenario as shown in FIG. 1 as an example, the method includes the following steps:

Step 202, obtaining latitude and longitude data of a task space.

Step 204, converting the task space into a latitude and longitude grid according to the latitude and longitude data.

The task space is divided into latitude and longitude grids according to preset longitude and latitude intervals, which can be determined according to factors such as the size of the task space and the number of flying targets; and the task space is converted into a latitude and longitude grid and representation of the location data can be simplified.

Step 206, according to the current locations of the flying targets and preset task radiuses, associating the latitude and longitude grid as the thermal association grid of the flying targets.

Radiuses of the flying targets can be set separately according to factors such as the platform types and maneuverability of the flying targets, or the same task radius can be set for all flying targets based on experience; and according to the values of the task radiuses and the current locations of the flying targets, an overlap condition between the task range of the flying targets and latitude and longitude grids thereof is determined, and the latitude and longitude grids that coincide with the task range of the flying targets are associated as the thermal association grid of the flying targets.

Step 208, according to the thermal association grid associated with the flying targets in the task space, constructing an aerial unit distribution thermal grid.

Specifically, the thermal value of each longitude and latitude grid in the task space is set to be 0, then the thermal association grid of flying targets in the task space is obtained, and the thermal values of the latitude and longitude grids associated with the thermal association grid of the flying targets are increased accordingly; and when the thermal association grid of all flying targets is obtained, the aerial unit distribution thermal grid is constructed. The magnitude of the thermal value added by the flying targets can be set separately according to the platform type, etc., or can be set to the same value uniformly.

Step 210, according to the thermal value of the aerial unit distribution thermal grid and the flying targets associated with the aerial unit distribution thermal grid, determining suspected task formation data in the task space.

The thermal value of the aerial unit distribution thermal grid reflects association between each longitude and latitude grid in the task space and the task range of each flying target; the flying targets associated with the same longitude and latitude grid have an overlapped task range, so the flying targets may be the target formation and are determined as a task suspected formation; and the set of all task suspected formations in the task space is the task suspected formation data in the task space.

Step 212, obtaining a suspected task area and a flying target trajectory corresponding to the suspected task formation data, and determining target formation of the task suspected formation data and the task area of the target formation according to the principle of time and space consistency.

After reaching the task area, the positions of the flying targets in the flying formation are stable in time and space, that is, the flying targets in the flying formation move within a fixed range for a period of time, which is the specific manifestation of the principle of time and space consistency in the flying formation. Therefore, it can be judged whether the flying targets are a flying formation based on the principle of time and space consistency and the trajectory of each flying target in the task suspected formation. Specifically, the distribution area of these flying targets at one or more moments in the past is firstly determined according to the trajectory of each flying target in the task suspected formation, and the suspected task area of the task suspected formation is determined based on the distribution area; then, the locations of the flying targets at another moments including the current moment are obtained; if a certain number of flying targets in the task suspected formation appear in the suspected task area and if the number is greater than the preset number, the task suspected formation is confirmed to have time and space consistency of the flying formation, is identified as the target formation, and the corresponding suspected task area is taken as the task area of the target formation.

It should be noted that there may be multiple target formations in a task space, so when a target formation is determined, it is necessary to assign the thermal association grid associated with all flying targets in the target formation to delete from the aerial unit distribution thermal grid, and then judge whether or not the next task suspected formation is the target formation according to the above process.

Step 214, according to the platform type of the flying targets in the target formation and the task target type of the task target in the task area, determining task intention of the target formation.

The platform type of the flying targets in the target formation can be determined according to the platform type of the flying targets. For example, the platform type of the to-air platform includes to-air tasks, the platform type of to-ground platforms includes to-ground tasks, and the platform type of composite platforms includes to-air tasks, to-ground tasks and composite tasks, etc. The task target type refers to the target type that may become the target of the task in the task area of the target formation, mainly including aerial targets and ground targets. According to the platform type of the flying targets in the target formation and the task target type of the task target in the task area, task intention of the target formation can be determined according to the preset task intention judging rule.

The target task intention identifying method based on the unit distributed thermal grid establishes the aerial unit distribution thermal grid of the task space and the thermal value thereof according to the task radiuses, the current location, the trajectory and the longitude and latitude data of the task space of the flying targets, determines the task suspected formation in the task space according to the thermal value and the flying targets associated with the aerial unit distribution thermal grid, identifies the target formation and the task area thereof from the task suspected formation according to the principle of time and space consistency, and determines the task intention of the target formation according to the platform type of the flying targets in the target formation and the task target type of the task target in the task area. The target task intention identifying method and device based on the unit distributed thermal grid, the computer equipment and the storage medium can directly identify the target formation, the task area and the task intention of the flying targets according to real-time obtained information such as the platform type of the flying targets, the flying trajectory, the location of the task target, the type of the task target and the like, thereby avoiding the problems of needing a great deal of priori knowledge as a data support, and needing a great deal of time and energy for establishing a database and a training algorithm while situation templates, expert systems, Bayesian networks, and deep learning methods are used to identify battlefield situations.

It should be understood that, although the various steps in the flow chart of FIG. 2 are displayed in sequence as indicated by the arrows, these steps are not necessarily performed in sequence in the order indicated by the arrows. Unless specifically stated herein, the execution of these steps is not strictly restricted in order, and these steps can be executed in other orders. Moreover, at least a part of the steps in FIG. 2 may include multiple sub-steps or multiple stages. These sub-steps or stages are not necessarily executed at the same moment, but can be executed at different moments. The sub-steps or stages are not necessarily performed sequentially, but may be performed alternately or alternately with at least a part of other steps or sub-steps or stages of other steps.

In one embodiment, the step of constructing the aerial unit distribution thermal grid according to the thermal association grid associated with the flying targets in the task space includes: according to the thermal association grid associated with the flying targets in the task space, obtaining the number of times that the latitude and longitude grids are associated with the thermal association grid of the flying targets; and generating thermal values of the latitude and longitude grids according to the number of times, and constructing an aerial unit distribution thermal grid.

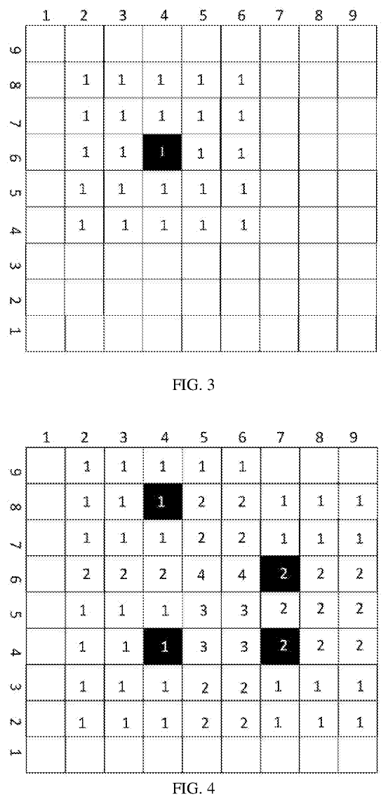

Specifically, as shown in FIG. 3, the task space is divided into 9bution thermal glongitude grids according to preset longitude and latitude intervals. The black grids represent the latitude and longitude grids where the flying targets are located, and the white grids represent the latitude and longitude grids without flying targets, and the number in the grids represents the thermal values of the latitude and longitude grids. The task radiuses of the flying targets are set to be the length of 2 grids, so the 5 the gride and longitude gridhs centered on the latitude and longitude grids of the current locations of the flying targets are the thermal association grid associated with the flying targets, and the thermal values thereof are all 1. Since there is only one flying target in the task space, the aerial unit distribution thermal grid is only related to the flying target. FIG. 4 shows the aerial unit distribution thermal grid when there are 4 flying targets in the task space. When the latitude and longitude grids are associated as the thermal association grid for multiple flying targets, the thermal values of the latitude and longitude grids are associated with the number of the flying targets.

In the embodiment, the thermal value of the aerial unit distribution thermal grid is determined according to the number of times that the latitude and longitude grids are associated as the thermal association grid of the flying targets, which realizes the uniform setting of the thermal value of each flying target in a simple and intuitive manner And the thermal value of the aerial unit distribution thermal grid directly reflects the number of associated flying targets thereof, which is suitable for target formation identification when the roles of flying targets in the flying formation are equal.

In one embodiment, the step of determining task suspected formation of the suspected task formation data in the task space according to the thermal value of the aerial unit distribution thermal grid and the flying targets associated with the aerial unit distribution thermal grid includes: obtaining the aerial unit distribution thermal grid with the largest thermal value when the thermal value of the aerial unit distribution thermal grid in the task space is greater than the preset value, generating a task suspected formation based on the flying targets associated with the aerial unit distribution thermal grid and deleting the flying targets and the thermal association grid corresponding to the task suspected formation; and according to the task suspected formation, determining the task suspected formation data in the task space.

Specifically, in the aerial unit distribution thermal grid, the maximum point of the grid thermal value is set to be O (if there are multiple points in the maximum, any one is denoted as O), and the corresponding grid number is (N_{Olat}, N_{Olon}), all aerial units within the range of the following grid numbers can be included in the suspected task formation corresponding to point O:

$${N}_{O\_} \text{?} ∼ \{ \begin{matrix}[ {N}_{Olat} - Δ {N}_{lat} , {N}_{Olon} + Δ {N}_{lat} ] , {N}_{Olat} - Δ {N}_{lat} > 1 {N}_{Olat} + Δ {N}_{lat} < ⌈ {Lat}_{e} / {L}_{Dlon} ⌉ \\ [ 1 , {N}_{Olat} + Δ {N}_{lat} ] , {N}_{Olat} - Δ {N}_{lat} < 1 \\ ⌈ {N}_{Olat} - Δ {N}_{lat} ⌈ {Lat}_{e} / {L}_{Olat} ⌉ ⌉ , {N}_{Olat} + Δ {N}_{lat} > ⌈ {Lat}_{e} / {L}_{Olat} ⌉\end{matrix} \\ {N}_{O\_} \text{?} ∼ \{ \begin{matrix}[ {N}_{Olon} - Δ {N}_{lat} , {N}_{Olon} + Δ {N}_{lon} ] , {N}_{Olon} - Δ {N}_{lon} > 1 {N}_{Olon} + Δ {N}_{lon} < ⌈ {Lon}_{e} / {L}_{Dlon} ⌉ \\ [ 1 , {N}_{Olon} + Δ {N}_{lom} ] , {N}_{Olon} - Δ {N}_{lon} < 1 \\ ⌈ {N}_{Olon} - Δ {N}_{lon} ⌈ {Lon}_{e} / {L}_{Olon} ⌉ ⌉ , {N}_{Olon} + Δ {N}_{lon} > ⌈ {Lon}_{e} / {L}_{Olon} ⌉\end{matrix} \\ \text{?} \text{indicates text missing or illegible when filed}$$

The task suspected formation corresponding to the point O is stored and is deleted on a heat map to delete the flying targets in the task suspected formation, and a heat map grid is regenerated. On the new thermal grid, the maximum point is taken and marked as O₂, and the above process is repeated to generate the suspected task formation corresponding to the O₂ point. In this way, the maximum value on the updated thermal grid is less than the thermal value and the preset value fₜₕᵣ, and the task suspected formation data including multiple groups of task suspected formations are obtained, and a formation list Fₗᵢₛₜ is generated according to the formation data.

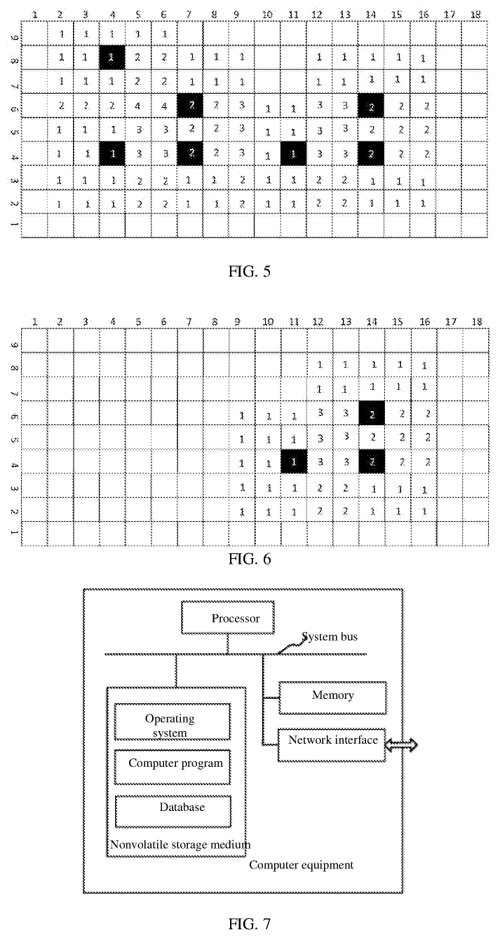

In the task space shown in FIG. 5, the preset thermal value is 3, the aerial unit distribution thermal grid with the thermal value of 4 is firstly obtained; when there are multiple aerial unit thermal grids with the thermal values of 4, one of the suspected task formations can be selected firstly according to the preset rule. Taking the task suspected formation generated by taking the aerial unit distribution thermal grid with coordinates of (6, 6) as a point O, the coordinates of the longitude and latitude grids where the associated flying targets are located are (4, 8), (4, 4), (7, 6) and (7, 4), these flying targets are generated into a task suspected formation, and these flying targets and corresponding thermal association grids thereof are deleted from the aerial unit distribution thermal grid, and the deleted aerial unit distribution thermal grid is shown in FIG. 6.

A grid with a thermal value not less than the preset thermal value is still in FIG. 6. Taking the task suspected formation generated by taking the aerial unit distribution thermal grid with coordinates of (13, 5) as a point O₂, the coordinates of the longitude and latitude grid where the associated flying targets are located are (11, 4) (14, 6) and (14, 4), these flying targets are generated into a task suspected formation, and these flying targets and corresponding thermal association grids thereof are deleted from the aerial unit distribution thermal grid, and the thermal values of the deleted aerial unit distribution thermal grids are all 0.

The generated two task suspected formations are determined as the task suspected formation data in the task space.

In the embodiment, by assuming a preset thermal value threshold, the number of flying targets in the generated task suspected formation can be controlled, and target formations of a required scale can be flexibly selected based on experience or different requirements for target formation identification.

In one embodiment, the step of obtaining a suspected task area of task suspected formation data, and determining target formation of the task suspected formation data and a task area of the target formation according to the principle of time and space consistency includes:

assuming that the task suspected formation data in the task space include m task suspected formations f₁, f₂, . . . fₘ, where the task suspected formation fᵢ includes n flying targets pᵢ₋₁, pᵢ₋₂, . . . pᵢ₋ₙ; assuming that the longitude and latitude values at the moment T of the flying targets are lonₚ(T) and latₚ(T), respectively, assuming that the current moment is T₀, and the previous j moments from near to far are T₋₁, T₋₂, T₋₃, T₋₄, . . . T₋ₖ . . . T₋ⱼ, obtaining the latitude and longitude values of the n flying targets of the task suspected formation fᵢ at the moments T₀, T₋₁, T₋₂, T₋₃, . . . T₋ₖ . . . T₋ⱼ, where k is greater than 0 and smaller than j;

$$\{ \begin{matrix}{lat}_{max} ( T ) = max ( {lat}_{{p}_{i - 1}} ( T ) , {lat}_{{p}_{i - 2}} ( T ) , … , {lat}_{{p}_{i - n}} ( T ) ) \\ {lon}_{max} ( T ) = max ( {lon}_{{p}_{i - 1}} ( T ) , {lon}_{{p}_{i - 2}} ( T ) , … , {lon}_{{p}_{i - n}} ( T ) ) \\ {lat}_{min} ( T ) = min ( {lat}_{{p}_{i - 1}} ( T ) , {lat}_{{p}_{i - 2}} ( T ) , … , {lat}_{{p}_{i - n}} ( T ) ) \\ {lon}_{min} ( T ) = min ( {lon}_{{p}_{i - 1}} ( T ) , {lon}_{{p}_{i - 2}} ( T ) , … , {lon}_{{p}_{i - n}} ( T ) )\end{matrix}$$

according to the latitude and longitude endpoint values, calculating an average latitude and longitude endpoint value of the task suspected formation fᵢ at moments T_{-k, T-(k+1)}, . . . T₋ⱼ as follows:

$$\{ \begin{matrix}{lat}_{argmax} = ( {lat}_{max} ( {T}_{- k} ) + {lat}_{max} ( {T}_{- ( k + 1 )} ) + … + {lat}_{max} ( {T}_{- j} ) ) / ( j - k + 1 ) \\ {lon}_{argmax} = ( {lon}_{max} ( {T}_{- k} ) + {lon}_{max} ( {T}_{- ( k + 1 )} ) + … + {lon}_{max} ( {T}_{- j} ) ) / ( j - k + 1 ) \\ {lat}_{argmax} = ( {lat}_{min} ( {T}_{- k} ) + {lat}_{min} ( {T}_{- ( k + 1 )} ) + … + {lat}_{min} ( {T}_{- j} ) ) / ( j - k + 1 ) \\ {lon}_{argmax} = ( {lon}_{min} ( {T}_{- k} ) + {lon}_{min} ( {T}_{- ( k + 1 )} ) + … + {lon}_{min} ( {T}_{- j} ) ) / ( j - k + 1 )\end{matrix}$$

obtaining the suspected task area of the task suspected formation based on the average longitude and latitude endpoint value, which can be marked as Zi: {(lat_{avgmin},lon_{avgmin}),(lat_{avgmin},lon_{avgmax}),(lat_{avgmax},lon_{avgmin}),(lat_{avgmax},lon_{avgmax})}.

According to the latitude and longitude values of the flying targets of the task suspected formation fᵢ at moments T₀, T₋₁, . . . T₋₍ₖ₋₁₎, obtaining frequency of appearances of the flying targets in the suspected task area and the position, on the center point of the suspected task area, of the target formation at moments T₀, T₋₁, T₋₍ₖ₋₁₎; obtaining the number of flying targets whose frequency of appearances is greater than a preset value, determining the task suspected formation fᵢ as the target formation and determining the corresponding suspected task area as a task area of the target formation when the frequency is greater than the preset value and a distance between location of the center point to the flying targets is smaller than the preset value. The preset values of the number of the flying targets appearing in the suspected task area and the number of the flying targets can be set according to the empirical values, or can be set according to factors such as the size of the task area.

Specifically, k is assumed to be 3, when the appearance rate of the flying targets in the suspected task area at moments T₀, T₋₁, and T₋₂, is higher than 65% (that is, at least two moments appear in the suspected task area), and when the number of flying targets meeting the above appearance probability is greater than 80%, the task is suspected of obeying the time and space consistency characteristics of the flying formation, and the specific implementation methods is as follows:

For the formation list Flist of the formation fᵢ:

n_{f}=0# formation obeys that a consistency member counter is cleared

for the formation fᵢ of the formation members pᵢ:

nₙ=0# formation members obey that a consistency moment counter is cleared

if lat_{avgmin}<latₚᵢ(T0)<lat_{avgmax} AND lon_{avgmin}<lonₚᵢ(T0)<lon_{avgmax}:

nₚ++

if lat_{avgmin}<latₚᵢ(T−1)<lat_{avgmax} AND lon_{avgmin}<lonₚᵢ(T−1)<lon_{avgmax}:

nₚ++

if lat_{avgmin}<latₚᵢ(T−2)<lat_{avgmax} AND lon_{avgmin}<lonₚᵢ(T−2)<lon_{avgmax}:

nₚ++

if nₚ/3>0 0.65:

n_{f}++

if n_{f}/nᵢ>0.80, #nᵢ is the total number of members of the formation fᵢ.

The appearance rate of formation members meets the requirements, and the formation fᵢ members are marked to obey the time and space consistency of the formation;

the maximum and minimum latitude and longitude values lat_{fi-max} (T₀), lat_{fi-min} (T₀), lon_{fi-max} (T₀) and lon_{fi-min} (T₀) of the task suspected formation fᵢ at moment T₀ and the coordinates of the location of the center point of the suspected task area are assumed as follows:

$$\{ \begin{matrix}{lat}_{cntr} ( T ) = \frac{{lat}_{max} ( T ) + {lat}_{min} ( T )}{2} \\ {lon}_{cntr} ( T ) = \frac{{lon}_{max} ( T ) + {lon}_{min} ( T )}{2}\end{matrix}$$

The three center points (lat_{fi-cntr}(T₀), lon_{fi-cntr} (T₀)), (lat_{fi-cntr}(T₋₁), lon_{fi-cntr}(T₋₁)), (lat_{fi-cntr}(T₋₂) and lon_{fi-cntr}(T₋₂) are of the suspected task area at moments T₀, T₋₁ and T⁻² are solved respectively to further solve pairwise deviation d of the center points of the three areas. Firstly, the latitude and longitude are processed to certain extent:

$${mlat}_{cntr} ( T ) = \{ \begin{matrix}{90}^{°} - {lat}_{cntr} ( T ) {lat}_{cntr} ( T ) & north latitude \\ {90}^{°} + {lat}_{cntr} ( T ) {lat}_{cntr} ( T ) & south latitude\end{matrix} \\ {mlon}_{cntr} ( T ) = \{ \begin{matrix}{lon}_{cntr} ( T ) {lon}_{cntr} ( T ) & east latitude \\ - {lon}_{cntr} ( T ) {lon}_{cntr} ( T ) & west latitude\end{matrix}$$

The radius of the earth is assumed to be RE to solve the pairwise distance d between the center points of the three regions:

$$\{ \begin{matrix}\begin{matrix}C = sin ( {mlat}_{cntr} ( {T}_{0} ) ) \times sin ( {mlat}_{cntr} ( {T}_{- 1} ) ) \times cos ( {mlon}_{cntr} ( {T}_{0} ) - {mlon}_{cntr} ( {T}_{- 1} ) ) + \\ cos ( {mlat}_{cntr} ( {T}_{0} ) ) \times cos ( {mlat}_{cntr} ( {T}_{- 1} ) )\end{matrix} \\ {d}_{0} = \frac{{R}_{1} / arccos ( C ) \times π}{180}\end{matrix}$$

the distance d₀ between the center points of the suspected task areas at moments T₀ and T₋₁, the distance d₁ between the center points of the suspected task areas at moments T₋₁ and T₋₂, and the distance d₂ between the center points of the suspected task areas at moments T₀ and T₋₂ can be solved to judge whether the center point position deviation d of the three suspected task areas exceeds the deviation threshold D_{thrd}, if the deviation is within the deviation threshold, the suspected task areas can be subjected to time and space consistency. The specific implementation method is as follows:

If the formation fᵢ members obey time and space consistency:

maximum and minimum latitude and longitude values of the formation fᵢ at moments T₀, T₋₁ and T₋₂ are calculated, and coordinates of location of the center point of the suspected task area at the three moments are calculated;

distances d₀, d₁ and d₂ between the center points of the suspected task areas at moments T₀, T₋₁ and T₋₂ are calculated, and whether or not the distances between the center points exceeds a deviation threshold smaller than D_{thrd} are compared.

if d₀<D_{thrd} AND d₁<D_{thrd} AND d₂<D_{thrd}:

the suspected task area is marked and recorded to obey time and space consistency

else:

the suspected task area is invalid, and the suspected task area of the task suspected formation cannot be judged.

In the embodiment, trajectory data of the flying targets in the task suspected formation are used to determine the distribution area of these flying targets at the past moments, and the distribution areas at multiple moments are calculated and averaged to obtain the suspected task area of the task suspected formation. According to the characteristics of the flying formation in terms of time and space consistency, whether the task suspected formation is a target formation or not is determined: when the locations of all corresponding flying targets at multiple moments in the past have a higher association with the suspected task area than the preset value, and when the deviation of the center point of the suspected task area is less than the preset value, the time and space consistency of the flying formation is shown, the flying formation is judged as the target formation, and the corresponding suspected task area is set as the task area of the target formation. In the embodiment, the characteristics of the flying targets in the flying formation in terms of time and space consistency are used to make the target formation identification results more accurate.

In one embodiment, the step of converting the task space into a latitude and longitude grid according to the latitude and longitude data includes: assuming that the latitude and longitude endpoint values of the task space are Lats, Late, Lons, and Lone, and dividing the task space into a latitude and longitude grid with a latitude value interval being LDlat and a longitude value interval being LDlon according to a preset length D; assuming that a latitude serial number is Nlat and a longitude serial number is Nlon so as to generate a mapping relationship among the generated latitude serial number, the longitude serial number and the latitude and longitude grid as follows:

$$\{ \begin{matrix}[ {Lat}_{s} , {Lat}_{s} + {N}_{lat} \times {L}_{Dlat} ] , {N}_{lat} = 1 \\ ( {Lat}_{s} + ( {N}_{lat} - 1 ) \times {L}_{Dlat} , {Lat}_{s} + {N}_{lon} \times {L}_{Dlat} ] , 1 < {N}_{lat} < ⌈ {Lat}_{e} / {L}_{Dlon} ⌉ \\ ( {Lat}_{s} + ( {N}_{lat} - 1 ) \times {L}_{Dlat} , {Lat}_{e} ] , {N}_{lat} = ⌈ {Lat}_{e} / {L}_{Dlat} ⌉\end{matrix} \\ \{ \begin{matrix}[ {Lon}_{s} , {Lon}_{s} + {N}_{lon} \times {L}_{Dlon} ] , {N}_{lon} = 1 \\ ( {Lon}_{s} + ( {N}_{lon} - 1 ) \times {L}_{Dlon} , {Lon}_{s} + {N}_{lon} \times {L}_{Dlon} ] , 1 < {N}_{lat} < ⌈ {Lat}_{e} / {L}_{Dlat} ⌉ \\ ( {Lon}_{s} + ( {N}_{lon} - 1 ) \times {L}_{Dlon} , {Lon}_{e} ] , {N}_{lon} = ⌈ {Lon}_{e} / {L}_{Dlon} ⌉\end{matrix} .$$

In the embodiment, the task space is converted into a latitude and longitude grid and a mapping relationship between latitude and longitude serial numbers and the latitude and longitude grid is generated into a mapping relationship table; and according to the mapping relationship table, any position in the task space is represented by simpler two-dimensional coordinates, which simplifies the way of representing location data.

one embodiment, the step of associating the latitude and longitude grids as the thermal association grid of the flying targets according to the current locations of the flying targets and preset task radiuses includes: according to the task radiuses of the flying targets, determining a task area of the flying targets; and according to the current locations of the flying targets, associating the latitude and longitude grids covered by the task area with the thermal association grid of the flying targets. Radiuses of the flying targets can be set separately according to factors such as the platform type and maneuverability of the flying targets, or can be set uniformly according to the empirical value.

the embodiment, according to the task radiuses of the flying targets and corresponding task areas thereof, the latitude and longitude grids are associated as the thermal association grid of the flying targets, which can intuitively reflect the role and influence range of the flying targets in the task space, and can provide basis for forming an intuitive air unit distribution thermal grid.

In one embodiment, the step of determining task intention of the target formation according to the platform type of the flying targets in the target formation and the task target type of the task target in the task area includes:

when the platform type of the flying targets in the target formation is a to-air platform or an unknown platform, and the task target type of the task target in the task area includes an aerial target, determining that the task intention of the target formation is a close-range aerial confrontation; when the platform type of the flying targets in the target formation is a to-air platform or an unknown platform, and the task target type of the task target in the task area is only a ground target, determining task intention of the target formation to be an air-to-ground confrontation; when the platform type of the flying targets in the target formation is a ground platform, and the task target type of the task target in the task area includes an aerial target, determining the task intention of the target formation to be a close-range aerial confrontation; when the platform type of the flying targets in the target formation is a ground platform, and the task target type of the task target in the task area is only a ground target, determining the task intention of the target formation to be an air-to-ground confrontation; and when the task target is not detected in the task area, determining the task intention of the target formation to be assembled on standby. Specifically, the task intention identification method of the target formation is as follows:

if the flying targets of the formation fᵢ and the task area obey time and space consistency:

if the formation fᵢ is mainly composed of aerial confrontation aircrafts or unknown aircrafts:

if there is an aerial task target in the task area:

the target formation intention is judged to be a close-range aerial confrontation and the target formation, the task area and the task target data are output

elif there is a ground task target in the task area

the target formation intention is judged to be an air to-ground confrontation and the target formation, the task area and the task target data are output

else:

the target formation intention is judged to be assembled on standby and the target formation, the task area and the task target data are output

elif the formation fᵢ is mainly composed of to-ground defense aircrafts:

if there is a ground task target in the task area:

the target formation intention is judged to be an air to-ground confrontation and the target formation, the task area and the task target data are output

elif there is an aerial task target in the task area

the target formation intention is judged to be a close-range aerial confrontation and the target formation, the task area and the task target data are output

else:

the target formation intention is judged to be assembled on standby and the target formation and the task area are output

The task intention of the target formation and the platform type of the flying targets in the target formation are tightly associated with the task target type of the task target in the task area of the target formation, and therefore, the task intention of the target formation can be judged according to the factors in terms of two aspects. Through the judgment rule set in the embodiment, the three main task intentions of the target formation can be quickly judged without the support of a large amount of prior data and the establishment of a situation template, training of a machine learning algorithm and the like. The judgment rule can be adjusted for being applied to various task intention identification tasks of the target formation more quickly and flexibly.

In one embodiment, the starting and ending latitude of the task space is assumed to be 0 to be the starting and ending longitude is assumed to be 0ting, and the latitudes and longitudes are all divided according to 0.09 g to 0.09 the like. The judgment rule can ch latitude and longitude grid is about 10 kilometers, which can be divided into 23 grids in the east-west direction and 12 grids in the north-south direction. There are 7 flying targets in the current task space, and serial numbers and coordinates thereof at each moment are shown in Table 1:

TABLE 1
Serial numbers and coordinates of flying targets at each moment

| | Coordinates of Aerial Unit at Each Moment | | | | | |
|---|---|---|---|---|---|---|
| Serial Number | T₀ | T₋₁ | T₋₂ | T₋₃ | T₋₄ | T₋₅ |
| 01 | 0.66° N | 0.81° N | 0.67° N | 0.44° N | 0.68° N | 0.73° N |
| | 0.35° E | 0.58° E | 0.56° E | 0.56° E | 0.74° E | 0.35° E |
| 02 | 0.46° N | 0.21° N | 0.42° N | 0.66° N | 0.27° N | 0.37° N |
| | 0.57° E | 0.32° E | 0.37° E | 0.35° E | 0.28° E | 0.26° E |
| 03 | 0.28° N | 0.47° N | 0.36° N | 0.26° N | 0.53° N | 0.28° N |
| | 0.31° E | 0.64° E | 0.58° E | 0.27° E | 0.34° E | 0.55° E |
| 04 | 0.32° N | 0.37° N | 0.68° N | 0.71° N | 0.72° N | 0.66° N |
| | 0.57° E | 0.59° E | 0.67° E | 0.72° E | 0.35° E | 0.73° E |
| 05 | 0.52° N | 0.43° N | 0.77° N | 0.72° N | 0.92° N | 0.98° N |
| | 1.22° E | 1.12° E | 1.05° E | 0.95° E | 0.87° E | 0.66° E |
| 06 | 0.38° N | 0.65° N | 0.51° N | 0.61° N | 0.73° N | 0.89° N |
| | 0.96° E | 0.86° E | 0.84° E | 0.72° E | 0.81° E | 0.56° E |
| 07 | 0.32° N | 0.53° N | 0.66° N | 0.89° N | 0.65° N | 0.82° N |
| | 1.12° E | 0.89° E | 0.79° E | 0.89° E | 0.61° E | 0.76° E |

D is equal to 10 km, the grid thermal radius is 20 km, and the thermal grid number is 2, the generated aerial unit distribution thermal grid at moment T₀ is shown in FIG. 5. The black grids represent the grids where the flying targets are located. Each value in the grid refers to the number of enemy targets read with the current grid as the center and a radius of 3 grids. The thermal value in the blank space is averagely 0. The preset thermal value is assumed to be 3, the task suspected formation data including 2 suspected formations can be obtained according to the method in the above-mentioned embodiment.

The time and space consistency of the suspected formation 1 is determined firstly, and the latitude and longitude range of the suspected task area of the formation 1 can be calculated to be 0.27istency of the suspected formation 1 is determined firstly, and the latitude and longitude range of the n the suspected task area at two or more moments. By taking the radius of the earth R_{E}=6371 km and D_{thrd}=8 km, the pairwise deviation of the task suspected formation 1 on the location of the center point of the suspected task area at moments T₀, T₋₁, and T₋₂, is separately 2.46 km, 6.98 km, and 4.91 km, which are within the judgment threshold, and therefore, the suspected task area of the task suspected formation meets the time and space consistency. Based on the above judgments, the suspected formation 1 meets the time and space consistency, and is identified as the target formation 1. However, there is no task target in the task area of target formation 1, so the intention of target formation 1 can be judged to be assembled on standby. The target formation members are 01, 02, 03, and 04, and the latitude and longitude range of the task area is 0.27° N-0.72° N and 0.27° E-0.73° E.

Then the suspected task formation 2 is determined, and the latitude and longitude range of the suspected task area of the task suspected formation 2 is calculated to be 0.72° N-0.93° N, 0.63° E-0.86° E, and coordinates of the flying targets in the task suspected formation 2 do not meet the requirements of the suspected task area at moments T0, T−1 and T−2, and therefore, time and space consistency of the flying formation cannot be met, and the flying targets are judged to be a task suspected formation 2 instead of the target formation.

A target task intention identifying device based on unit distribution thermal grid, includes:

a latitude and longitude data obtaining module for obtaining latitude and longitude data of a task space;

a latitude and longitude grid generating module for converting the task space into latitude and longitude grids according to the latitude and longitude data;

a thermal association grid associating module for associating the latitude and longitude grids as the thermal association grid of the flying targets according to the current locations of the flying targets and preset task radiuses;

an aerial unit distribution thermal grid constructing module for constructing an aerial unit distribution thermal grid according to the thermal association grid associated with the flying targets in the task space;

a task suspected formation identifying module for determining suspected task formation data in the task space according to the thermal value of the aerial unit distribution thermal grid and the flying targets associated with the aerial unit distribution thermal grid;

a target formation identifying module for obtaining a suspected task area and a flying target trajectory corresponding to the suspected task formation data, and determining target formation of the task suspected formation data and the task area of the target formation according to the principle of time and space consistency; and

a task intention identifying module for determining task intention of the target formation according to the platform type of the flying targets in the target formation and the task target type of the task target in the task area.

In one embodiment, the aerial unit distribution thermal grid constructing module is used for: according to the thermal association grid associated with the flying targets in the task space, obtaining the number of times that the latitude and longitude grids are associated with the thermal association grid of the flying targets; and generating thermal values of the latitude and longitude grids according to the number of times, and constructing an aerial unit distribution thermal grid.

In one embodiment, the task suspected formation identifying module is used for: obtaining the aerial unit distribution thermal grid with the largest thermal value when the thermal value of the aerial unit distribution thermal grid in the task space is greater than the preset value, generating a task suspected formation based on the flying targets associated with the aerial unit distribution thermal grid and deleting the flying targets and thermal association grid corresponding to the task suspected formation; and

In one embodiment, the target formation identifying module is used for: assuming that the task suspected formation data in the task space include m task suspected formations f₁, f₂, . . . fₘ, where the task suspected formation fᵢ includes n flying targets pᵢ₋₁, pᵢ₋₂, . . . pᵢ₋ₙ; assuming that the longitude and latitude values at the moment T of the flying targets are lonₚ(T) and latₚ(T), respectively, assuming that the current moment is T₀,

and the previous j moments from near to far are T₋₁, T₋₂, T₋₃, T₋₄, . . . T₋ₖ . . . T₋ⱼ, obtaining the latitude and longitude values of the n flying targets of the task suspected formation fᵢ at the moments T₀, T₋₁, T₋₂, T₋₃, . . . T₋ₖ . . . T₋ⱼ, where k is greater than 0 and smaller than j;

according to the latitude and longitude values, calculating latitude and longitude endpoint values of the task suspected formation fᵢ at T−k, T−(k+1), T−j as follows:

$$\{ \begin{matrix}{lat}_{max} ( T ) = max ( {lat}_{{p}_{i - 1}} ( T ) , {lat}_{{p}_{i - 2}} ( T ) , … , {lat}_{{p}_{i - n}} ( T ) ) \\ {lon}_{max} ( T ) = max ( {lon}_{{p}_{i - 1}} ( T ) , {lon}_{{p}_{i - 2}} ( T ) , … , {lon}_{{p}_{i - n}} ( T ) ) \\ {lat}_{min} ( T ) = min ( {lat}_{{p}_{i - 1}} ( T ) , {lat}_{{p}_{i - 2}} ( T ) , … , {lat}_{{p}_{i - n}} ( T ) ) \\ {lon}_{min} ( T ) = min ( {lon}_{{p}_{i - 1}} ( T ) , {lon}_{{p}_{i - 2}} ( T ) , … , {lon}_{{p}_{i - n}} ( T ) )\end{matrix}$$

according to the latitude and longitude endpoint values, calculating an average latitude and longitude endpoint value of the task suspected formation fᵢ at moments T_{-k, T-(k+1)}, . . . T−j as follows:

$$\{ \begin{matrix}{lat}_{argmax} = ( {lat}_{max} ( {T}_{- k} ) + {lat}_{max} ( {T}_{- ( k + 1 )} ) + … + {lat}_{max} ( {T}_{- j} ) ) / ( j - k + 1 ) \\ {lon}_{argmax} = ( {lon}_{max} ( {T}_{- k} ) + {lon}_{max} ( {T}_{- ( k + 1 )} ) + … + {lon}_{max} ( {T}_{- j} ) ) / ( j - k + 1 ) \\ {lat}_{argmax} = ( {lat}_{min} ( {T}_{- k} ) + {lat}_{min} ( {T}_{- ( k + 1 )} ) + … + {lat}_{min} ( {T}_{- j} ) ) / ( j - k + 1 ) \\ {lon}_{argmax} = ( {lon}_{min} ( {T}_{- k} ) + {lon}_{min} ( {T}_{- ( k + 1 )} ) + … + {lon}_{min} ( {T}_{- j} ) ) / ( j - k + 1 )\end{matrix}$$

According to the average latitude and longitude endpoint value, obtaining the suspected task area of the task suspected formation; according to the latitude and longitude values of the flying targets of the task suspected formation fᵢ at moments T₀, T₋₁, . . . T₋₍ₖ₋₁₎, obtaining frequency of appearances of the flying targets in the suspected task area and the location, on the center point of the suspected task area, of the target formation at moments T₀, T₋₁, . . . T₋₍ₖ₋₁₎, obtaining the number of flying targets whose frequency of appearances is greater than a preset value, determining the task suspected formation fᵢ as the target formation and determining the corresponding suspected task area as a task area of the target formation when the frequency is greater than the preset value and a distance between location of the center point to the flying targets is smaller than the preset value.

In one embodiment, the latitude and longitude grid generating module is used for: assuming that the latitude and longitude endpoint values of the task space are Lats, Late, Lons, and Lone, and dividing the task space into a latitude and longitude grid with a latitude value interval being LDlat and a longitude value interval being LDlon according to a preset length D; assuming that a latitude serial number is Nlat and a longitude serial number is Nlon so as to generate a mapping relationship among the generated latitude serial number, the longitude serial number and the latitude and longitude grid as follows:

$$\{ \begin{matrix}[ {Lat}_{s} , {Lat}_{s} + {N}_{lat} \times {L}_{Dlat} ] , {N}_{lat} = 1 \\ ( {Lat}_{s} + ( {N}_{lat} - 1 ) \times {L}_{Dlat} , {Lat}_{s} + {N}_{lon} \times {L}_{Dlat} ] , 1 < {N}_{lat} < ⌈ {Lat}_{e} / {L}_{Dlon} ⌉ \\ ( {Lat}_{s} + ( {N}_{lat} - 1 ) \times {L}_{Dlat} , {Lat}_{e} ] , {N}_{lat} = ⌈ {Lat}_{e} / {L}_{Dlat} ⌉\end{matrix} \\ \{ \begin{matrix}[ {Lon}_{s} , {Lon}_{s} + {N}_{lon} \times {L}_{Dlon} ] , {N}_{lon} = 1 \\ ( {Lon}_{s} + ( {N}_{lon} - 1 ) \times {L}_{Dlon} , {Lon}_{s} + {N}_{lon} \times {L}_{Dlon} ] , 1 < {N}_{lat} < ⌈ {Lat}_{e} / {L}_{Dlat} ⌉ \\ ( {Lon}_{s} + ( {N}_{lon} - 1 ) \times {L}_{Dlon} , {Lon}_{e} ] , {N}_{lon} = ⌈ {Lon}_{e} / {L}_{Dlon} ⌉\end{matrix} .$$

In one embodiment, the thermal association grid associating module is used for: according to the task radiuses of the flying targets, determining a task area of the flying targets; and according to the current locations of the flying targets, associating the latitude and longitude grids covered by the task area as the thermal association grid of the flying targets.

In one embodiment, the task intention identifying module is used for: when the platform type of the flying targets in the target formation is a to-air platform or an unknown platform, and the task target type of the task target in the task area includes an aerial target, determining that the task intention of the target formation is a close-range aerial confrontation; when the platform type of the flying targets in the target formation is a to-air platform or an unknown platform, and the task target type of the task target in the task area is only a ground target, determining task intention of the target formation to be an air-to-ground confrontation; when the platform type of the flying targets in the target formation is a ground platform, and the task target type of the task target in the task area includes an aerial target, determining the task intention of the target formation to be a close-range aerial confrontation; when the platform type of the flying targets in the target formation is a ground platform, and the task target type of the task target in the task area is only a ground target, determining the task intention of the target formation to be an air-to-ground confrontation; and when the task target is not detected in the task area, determining the task intention of the target formation to be assembled on standby.

For the specific definition of the target task intention identifying device based on the unit distribution thermal grid, please refer to the above definition of the target task intention identifying method based on the unit distribution thermal grid, which will not be described again herein. Each module in the target task intention identifying device based on the unit distribution thermal grid can be implemented in whole or in part by software, hardware, and a combination thereof. The above-mentioned modules may be embedded in the form of hardware or independent of the processor in the computer equipment, or may be stored in the memory of the computer equipment in the form of software, so that the processor can call and execute the operations corresponding to the above-mentioned modules.

In one embodiment, computer equipment is provided. The computer equipment may be a server, and an internal structure diagram thereof may be as shown in FIG. 7. The computer equipment includes a processor, a memory, a network interface and a database connected through a system bus. The processor of the computer equipment is used to provide calculation and control capabilities. The memory of the computer equipment includes a non-volatile storage medium and an internal memory. The non-volatile storage medium stores an operating system, a computer program, and a database. The internal memory provides an environment for the operation of the operating system and computer programs in the non-volatile storage medium. The database of the computer equipment is used to store the trajectory of the flying targets, the task suspected formation data and corresponding suspected task range thereof, target formation and corresponding task range and task intention thereof as well as data such as longitude and latitude of the task space. The network interface of the computer equipment is used to communicate with an external terminal through a network connection. The computer program, which executed by the processor, is implemented to realize a target task intention identifying method based on the unit distribution thermal grid.

A person skilled in the art should understand that the structure shown in FIG. 7 is only a block diagram of part of the structure related to the solution of the present application, and does not constitute a limitation on the computer equipment to which the solution of the present application is applied. The specific computer equipment may include more or fewer parts than shown in the figure, or combine some parts, or have different part layouts.

Computer equipment includes a memory and a processor, where the memory stores a computer program, when executed by a processor, that implements the steps of the method in any one of the foregoing embodiments.

A computer-readable storage medium stores computer program, when executed by a processor, that implements the steps of the method in any one of the foregoing embodiments.

A person of ordinary skill in the art can understand that all or part of the processes in the above-mentioned embodiment methods can be implemented by instructing relevant hardware through a computer program. The computer program can be stored in a non-volatile computer readable storage medium. When the computer program is executed, the procedures in the embodiments of the above-mentioned method can be included. Any reference to memory, storage, database or other media used in the embodiments provided in the present application may include a non-volatile and/or volatile memory. Non-volatile memory may include read only memory (ROM), programmable ROM (PROM), electrically programmable ROM (EPROM), electrically erasable programmable ROM (EEPROM), or flash memory. Volatile memory may include random access memory (RAM) or external cache memory. As an illustration and not a limitation, RAM is available in many forms, such as static RAM (SRAM), dynamic RAM (DRAM), synchronous DRAM (SDRAM), double-data-rate SDRAM (DDRSDRAM), enhanced SDRAM (ESDRAM), synchronous link (Synchlink) DRAM (SLDRAM), memory bus (Rambus) direct RAM (RDRAM), direct memory bus dynamic RAM (DRDRAM), and memory bus dynamic RAM (RDRAM), etc.

The technical features of the above embodiments can be combined arbitrarily. In order to make the description concise, all possible combinations of the technical features in the above embodiments are not described. However, as long as there is no contradiction in the combination of these technical features, it should be considered as the range described in this specification.

The above-mentioned embodiments only express several implementation manners of the present application, and descriptions thereof are relatively specific and detailed, but should not be understood as limiting the scope of present invention. It should be noted that the improvements and the modifications made by a person of ordinary skill in the art without departing from the concept of the present application shall be within the protective range of the present application. Therefore, the protective scope of the invention should correspond to the scope of claims in the present application patent.

1. A target task intention identifying method based on a unit distribution thermal grid, comprising: obtaining latitude and longitude data of a task space;
converting the task space into latitude and longitude grids according to the latitude and longitude data;
according to current locations of flying targets and preset task radiuses, associating the latitude and longitude grids as the thermal association grid of the flying targets;
according to the thermal association grid associated with the flying targets in the task space, constructing an aerial unit distribution thermal grid;
according to the thermal value of the aerial unit distribution thermal grid and the flying targets associated with the aerial unit distribution thermal grid, determining suspected task formation data in the task space;
obtaining a suspected task area and a flying target trajectory corresponding to the suspected task formation data, and determining target formation of the task suspected formation data and the task area of the target formation according to the principle of time and space consistency; and
according to the platform type of the flying targets in the target formation and the task target type of the task target in the task area, determining task intention of the target formation.

2. The method according to claim 1, wherein according to the thermal association grid associated with the flying targets in the task space, the step of constructing an aerial unit distribution thermal grid comprises:
according to the thermal association grid associated with the flying targets in the task space, obtaining the number of times that the latitude and longitude grids are associated with the thermal association grid of the flying targets; and
generating thermal values of the latitude and longitude grids according to the number of times, and constructing an aerial unit distribution thermal grid.

3. The method according to claim 2, wherein according to the thermal value of the aerial unit distribution thermal grid and the flying targets associated with the aerial unit distribution thermal grid, the step of determining suspected task formation data in the task space comprises:
obtaining the aerial unit distribution thermal grid with the largest thermal value when the thermal value of the aerial unit distribution thermal grid in the task space is greater than the preset value, generating a task suspected formation based on the flying targets associated with the aerial unit distribution thermal grid and deleting the flying targets and thermal association grid corresponding to the task suspected formation; and
according to the task suspected formation, determining the task suspected formation data in the task space.

4. The method according to claim 1, wherein the step of obtaining a suspected task area of task suspected formation data, and determining target formation of the task suspected formation data and a task area of the target formation according to the principle of time and space consistency comprises:
assuming that the task suspected formation data in the task space include m task suspected formations f₁, f₂, . . . fₘ, where the task suspected formation fᵢ includes n flying targets pᵢ₋₁, pᵢ₋₂, . . . pᵢ₋ₙ; assuming that the longitude and latitude values at the moment T of the flying targets are lonₚ(T) and latₚ(T), respectively, assuming that the current moment is T₀, and the previous j moments from near to far are T₋₁, T₋₂, T₋₃, T₋₄, . . . T₋ₖ . . . T₋ⱼ, obtaining the latitude and longitude values of the n flying targets of the task suspected formation fᵢ at the moments T₀, T₋₁, T₋₂, T₋₃, . . . T₋ₖ . . . T₋ⱼ, where k is greater than 0 and smaller than j;
according to the latitude and longitude values, calculating latitude and longitude endpoint values of the task suspected formation fᵢ at T₋ₖ, T₋₍ₖ₊₁₎, T₋ⱼ as follows:
according to the latitude and longitude endpoint values, calculating an average latitude and longitude endpoint value of the task suspected formation fᵢ at moments T₋ₖ, T₋₍ₖ₊₁₎, . . . T₋ⱼ as follows:
$$\{ \begin{matrix}{lat}_{argmax} = ( {lat}_{max} ( {T}_{- k} ) + {lat}_{max} ( {T}_{- ( k + 1 )} ) + … + {lat}_{max} ( {T}_{- j} ) ) / ( j - k + 1 ) \\ {lon}_{argmax} = ( {lon}_{max} ( {T}_{- k} ) + {lon}_{max} ( {T}_{- ( k + 1 )} ) + … + {lon}_{max} ( {T}_{- j} ) ) / ( j - k + 1 ) \\ {lat}_{argmax} = ( {lat}_{min} ( {T}_{- k} ) + {lat}_{min} ( {T}_{- ( k + 1 )} ) + … + {lat}_{min} ( {T}_{- j} ) ) / ( j - k + 1 ) \\ {lon}_{argmax} = ( {lon}_{min} ( {T}_{- k} ) + {lon}_{min} ( {T}_{- ( k + 1 )} ) + … + {lon}_{min} ( {T}_{- j} ) ) / ( j - k + 1 )\end{matrix}$$
obtaining the suspected task area of the task suspected formation based on the average longitude and latitude endpoint value;
according to the latitude and longitude values of the flying targets of the task suspected formation fᵢ at moments T₀, T₋₁, . . . T₋₍ₖ₋₁₎, obtaining frequency of appearances of the flying targets in the suspected task area and the location, on the center point of the suspected task area, of the target formation at moments T₀, T₋₁, . . . T₋₍ₖ₋₁₎;
obtaining the number of flying targets whose frequency of appearances is greater than a preset value, determining the task suspected formation fᵢ as the target formation and determining the corresponding suspected task area as a task area of the target formation when the frequency is greater than the preset value and a distance between the location of the center point to the flying targets is smaller than the preset value.

5. The method according to claim 1 wherein the step of converting the task space into latitude and longitude grids according to the latitude and longitude data comprises:
assuming that the latitude and longitude endpoint values of the task space are Latₛ, Latₑ, Lon_{g}, and Lonₑ, and dividing the task space into a latitude and longitude grid with a latitude value interval being L_{Dlat} and a longitude value interval being L_{Dlon} according to a preset length D; and
assuming that a latitude serial number of the latitude and longitude grid is Nₗₐₜ and a longitude serial number is Nₗₒₙ, generating a mapping relationship among the generated latitude serial number, the longitude serial number and the latitude and longitude grid as follows:
$$\{ \begin{matrix}[ {Lat}_{s} , {Lat}_{s} + {N}_{lat} \times {L}_{Dlat} ] , {N}_{lat} = 1 \\ ( {Lat}_{s} + ( {N}_{lat} - 1 ) \times {L}_{Dlat} , {Lat}_{s} + {N}_{lon} \times {L}_{Dlat} ] , 1 < {N}_{lat} < ⌈ {Lat}_{e} / {L}_{Dlon} ⌉ \\ ( {Lat}_{s} + ( {N}_{lat} - 1 ) \times {L}_{Dlat} , {Lat}_{e} ] , {N}_{lat} = ⌈ {Lat}_{e} / {L}_{Dlat} ⌉\end{matrix} \\ \{ \begin{matrix}[ {Lon}_{s} , {Lon}_{s} + {N}_{lon} \times {L}_{Dlon} ] , {N}_{lon} = 1 \\ ( {Lon}_{s} + ( {N}_{lon} - 1 ) \times {L}_{Dlon} , {Lon}_{s} + {N}_{lon} \times {L}_{Dlon} ] , 1 < {N}_{lat} < ⌈ {Lat}_{e} / {L}_{Dlat} ⌉ \\ ( {Lon}_{s} + ( {N}_{lon} - 1 ) \times {L}_{Dlon} , {Lon}_{e} ] , {N}_{lon} = ⌈ {Lon}_{e} / {L}_{Dlon} ⌉\end{matrix} .$$

6. The method according to claim 1, wherein according to the current locations of the flying targets and preset task radiuses, the step of associating the latitude and longitude grids as the thermal association grid of the flying targets comprises:
according to the task radiuses of the flying target, determining a task area of the flying targets; and
according to the current locations of the flying targets, associating the latitude and longitude grids covered by the task area as the thermal association grid of the flying targets.

7. The method according to claim 1, wherein according to the platform type of the flying targets in the target formation and the task target type of the task target in the task area, the step of determining task intention of the target formation comprises:
when the platform type of the flying targets in the target formation is a to-air platform or an unknown platform, and the task target type of the task target in the task area comprises an aerial target, determining that the task intention of the target formation is a close-range aerial confrontation;
when the platform type of the flying targets in the target formation is a to-air platform or an unknown platform, and the task target type of the task target in the task area is only a ground target, determining task intention of the target formation to be an air-to-ground confrontation;
when the platform type of the flying targets in the target formation is a ground platform, and the task target type of the task target in the task area comprises an aerial target, determining the task intention of the target formation to be a close-range aerial confrontation;
when the platform type of the flying targets in the target formation is a ground platform, and the task target type of the task target in the task area is only a ground target, determining the task intention of the target formation to be an air-to-ground confrontation; and
when the task target is not detected in the task area, determining the task intention of the target formation to be assembled on standby.

8. A target task intention identifying device based on a unit distribution thermal grid, comprising: a latitude and longitude data obtaining module for obtaining latitude and longitude data of a task space;
a latitude and longitude grid generating module for converting the task space into latitude and longitude grids according to the latitude and longitude data; a thermal association grid associating module for associating the latitude and longitude grids as the thermal association grid of the flying targets according to the current location of the flying targets and preset task radiuses;
an aerial unit distribution thermal grid constructing module for constructing an aerial unit distribution thermal grid according to the thermal association grid associated with the flying targets in the task space;
a task suspected formation identifying module for determining suspected task formation data in the task space according to the thermal value of the aerial unit distribution thermal grid and the flying targets associated with the aerial unit distribution thermal grid;
a target formation identifying module for obtaining a suspected task area and a flying target trajectory corresponding to the suspected task formation data, and determining target formation of the task suspected formation data and the task area of the target formation according to the principle of time and space consistency; and
a task intention identifying module for determining task intention of the target formation according to the platform type of the flying targets in the target formation and the task target type of the task target in the task area.

9. A computer equipment, comprising a memory and a processor, wherein the memory stores a computer program, when executed by the processor that implements the steps of the method according to claim 1.

10. A computer-readable storage medium, storing computer program, when executed by a processor, that implements the steps of the method according to claim 1.
